(19) United States
(12) Patent Application Publication
(10) Pub. No.: US 2003/0140249 A1
(43) Pub. Date: Jul. 24, 2003

(54) Security level information offering method and system

(76) Inventors: Yoshihito Taninaka, Tokyo (JP); Noriaki Ohura, Tokyo (JP)

Correspondence Address: DANN DORFMAN HERRELL & SKILLMAN, SUITE 720, 1601 MARKET STREET, PHILADELPHIA, PA, 19103-2307, US

(21) Appl. No.: 10/092,814

(22) Filed: Mar. 7, 2002

(30) Foreign Application Priority Data
Jan. 18, 2002 (JP) 2002-010888

(51) Int. Cl. H04L 9/00

(52) U.S. Cl. 713/201

(57) ABSTRACT

A system of security information processed such that it can be understood by a person with insufficient knowledge about security technologies is provided. The system comprises a vulnerability information storing unit for storing at least threat level values of vulnerabilities of a computer system to be monitored; a vulnerability information offering unit to extract vulnerability information to be applied to said computer system from said vulnerability information storing unit based on the configuration information of the computer system, and to associate the vulnerability information with this computer system; a vulnerability modification information storing unit for storing the information on whether or not a system manager has applied modification work based on this vulnerability information; and a security level computing unit for computing, regarding a specific equipment, a security level regarding a vulnerability of said equipment from a type of this equipment, the threat level value of the vulnerability that has not been modified with regarding this equipment, and the number or days while the vulnerability has been left without any modification taken.

This application claims the benefit of Japanese Patent Application No.2002-10888 filed on Jan. 18, 2002, the entire contents of which are incorporated by reference.

### BACKGROUND OF THE INVENTION

The present invention generally relates to a method and system, which can accurately evaluate and offer in real time the security level of a computer system group, such as one that is connected to a network.

Recently, networks and servers at corporations and government offices have frequently been attacked by crackers or infected with new viruses. With the frequent occurrence of such damages, strengthening of network security has been called for. To strengthen the network security, it is necessary to constantly and accurately grasp the security level of a network and equipments within a corporation that are connected to the network.

Parameters used to evaluate the security level comprise static elements such as the hardware and software configurations of a network and computers, and dynamic elements, which occur responding to the vulnerability information generated daily, and fluctuate as counter-measures are taken to cope with vulnerabilities. For a corporation that uses information technologies in its corporate activities, the business risks will increase endlessly unless counter-measures are promptly taken to cope with these dynamic elements. Therefore, controlling the dynamic elements has become a very important issue for business executives.

However, conventionally, a system manager has been solely in charge of grasping this security level. An executive could do nothing but believe what the system manager reports. On the other hand, the security level may drop due to a negligence of the system manager. Therefore, controlling the security level taking such a factor into consideration used to be very difficult.

It is extremely difficult, because of the nature of the issue, which is too technical, for an executive to find and grasp the information necessary for his/her own system from among vast amounts of security information and to take the necessary counter-measures without a delay.

### BRIEF SUMMARY OF THE INVENTION

The present invention was made considering aforementioned situation. The object of the invention is to offer a system and method, which can promptly offer security information reflecting the counter-measures that a system manager has taken, wherein the information is structured such that it can be understood even by a business executive who does not have sufficient knowledge on security.

According to the first aspect of the present invention, a security level information offering method is offered; said method comprising the steps of: (a) specifying a vulnerability of a specific equipment based on configuration information on the equipment and associating this vulnerability information with the aforementioned equipment, wherein this vulnerability information contains the threat level value of the vulnerability; (b) computing a security level value of a vulnerability of a specific equipment from the type of this equipment, the threat level value of the vulnerability, that has not been coped with regarding this equipment, and the number of days while the vulnerability has been left without any counter-measure taken for it; and (c) outputting security level information based on the security level value obtained in the aforementioned step (b).

According to this configuration, when there is information on a vulnerability for which no counter-measure been taken, its security level value can be computed based on the type of the equipment, the threat level of the vulnerability and the number of days while the vulnerability has been left without any counter-measure taken for it; and security level information can be generated based on the security level value.

It is preferable that this method further comprises the steps of (d) computing the security value of said equipment by comparing security values of vulnerabilities when there are a plurality of vulnerabilities that have not be dealt with and associated with said equipment, and setting a security value with the highest level of threat among the security values of said vulnerabilities as the security value of said equipment, and that the aforementioned step (c) outputs security level information based on the security value of said equipment.

According to this configuration, when there is information on a plurality of vulnerabilities associated with a specific equipment, the security value based on the information on the vulnerability with the highest level of threat can be set as the security value of aforementioned equipment.

It is desirable in this case that the method further comprises (e) a step of computing the security value of a network by comparing the security values of equipments when there are a plurality of equipments connected to the network, and setting a security value with the highest level of threat among the security values of the aforementioned equipments as the security value of said network; and that the aforementioned step (c) outputs security level information based on the security level of aforementioned network.

According to this configuration, when a plurality of equipments are connected to the network, the security value of the network as a whole can be computed based on the security values of the equipments obtained as described above.

Further, according to an embodiment of this invention, in the aforementioned step (c), security information is outputted based on both security value obtained in the step (b) and the basic security information computed based on the basic configuration, etc. of the equipment and the network.

According to another embodiment, the aforementioned step (c) comprises a process of expressing the aforementioned security value in comparison with a security reference value of said system or the network to which this system is connected.

According to this configuration, the reference security value for which said system or network should meet can be predetermined, and the current security value can be expressed in comparison with the reference security value. In this manner, even an executive who has not clearly grasped the reference value of the security level of his own corporation will be able to understand the current security level easily as it is relatively expressed in terms of the relationship with the reference value.

According to the second aspect of the present invention, a system to compute the security level of a computer system to be monitored is offered; said system comprising an configuration information storing unit to store the configuration information on the computer; a vulnerability information storing unit to store various types of updated vulnerability information containing at least a threat level value of a vulnerability; a vulnerability information offering unit to extract the vulnerability information to be applied to said computer from the aforementioned vulnerability information storing unit based on the aforementioned configuration information, and to associate it with this computer system; a vulnerability modification information storing unit to store the information on whether or not the system manager has applied modification work based on this vulnerability information; a security level computing unit to compute a security level value of a vulnerability for a specific equipment from the type of this equipment, the threat level value of the vulnerability not coped with on this equipment, and the number of days while the vulnerability has been left without any counter-measure taken for it; and a security level information generating unit to generate and output security level information based on the security level value obtained in the aforementioned computing unit.

According to this configuration, a system in which the aforementioned method according to the first aspect of the present invention can be implemented will be offered.

It is preferable that this system further comprises a security level value comparing unit to compute a security value of said equipment by comparing security values of vulnerabilities when there are a plurality of vulnerabilities not coped with associated with said equipment, and setting the security value with the highest level of threat among the security values of respective vulnerabilities as the security value of said equipment; and that the aforementioned security level information generating unit generates security level information based on the security value of said equipment. In this case, it is desirable that the aforementioned security level value comparing unit computes the security value of said network by comparing security values of equipments when a plurality of equipments are connected to the network, and setting a security value with the highest level of threat among the security values of the equipments as the security value of said network; and that the aforementioned security level information generating unit outputs security level information based on the security value of said network.

According to another embodiment of this invention, the aforementioned security level information generating unit outputs security information based on both security value obtained in the aforementioned security level computing unit and basic security information computed based on the basic configuration, etc. of the equipments or the network.

Further, according to another embodiment of this invention, it is desirable that the aforementioned security level information generating unit expresses the aforementioned security value in comparison with the security reference value of said system or the network to which this system is connected.

Further, the other features and the prominent effects of the present invention will be more clearly understood by referring to the following detailed description of the preferred embodiment and the attached drawings.

### BRIEF DESCRIPTION OF THE DRAWINGS

FIG. 1 shows a schematic block diagram of an embodiment of the present invention.

FIG. 2 shows a diagram to explain the configuration of computer system configuration information.

FIG. 3 shows a diagram to explain the configuration of security level values.

FIG. 4 shows a diagram to explain the configuration of vulnerability information.

FIG. 5 shows a process diagram of the updating process for vulnerability DB.

FIG. 6 shows a login screen.

FIG. 7 shows a screen to offer information to the system manager.

FIG. 8 shows a configuration information registration screen.

FIG. 9 shows a screen that displays a list of vulnerability information.

FIG. 10 shows a screen that displays details on vulnerability information.

FIG. 11 shows an input screen for vulnerability modification work.

FIG. 12 shows a screen to offer information to a manger of an organization.

FIG. 13 shows a screen to offer security level information to a manager of an organization.

FIG. 14 shows a flow chart of the security level value computing process.

### DETAILED DESCRIPTION OF THE PREFERRED EMBODIMENTS

Preferred embodiments of the present invention will be described in detail below with reference to the accompanying drawings.

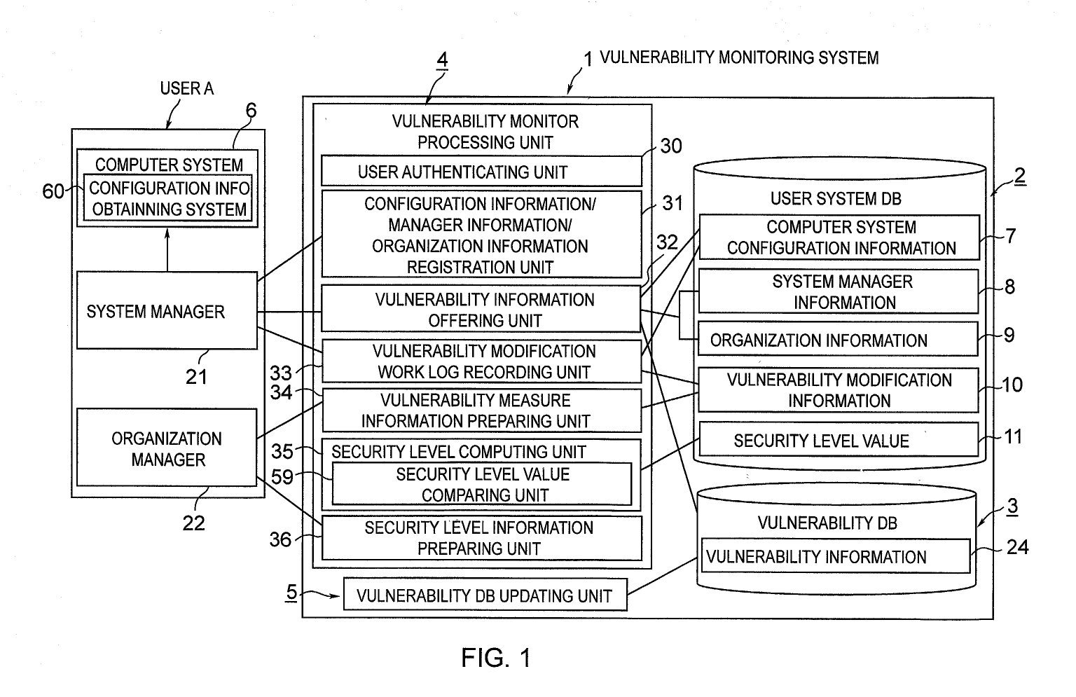

In FIG. 1, reference numeral 1 denotes a security level information offering system according to the present embodiment. FIG. 1 shows a schematic block diagram of this system 1.

This system 1 comprises a user system DB 2, which stores various information 7-11 related to a user A and this user's A computer system 6 to be monitored; a vulnerability DB 3, which stores information 24 on the vulnerability of the computer system 6, a vulnerability monitor processing unit 4, which offers the vulnerability information 24 in the aforementioned vulnerability DB 3 based on the user information 7-11 stored in the aforementioned user system DB 2, as well as computing the security level; and a vulnerability DB updating unit 5, which generates the aforementioned vulnerability information 24 and updates the aforementioned vulnerability DB 3.

In the user system DB 2, for each user, the configuration information 7 on the aforementioned computer system 6, the system manager information 8, the organization information 9, the vulnerability modification information 10 and the security level value 11 are stored.

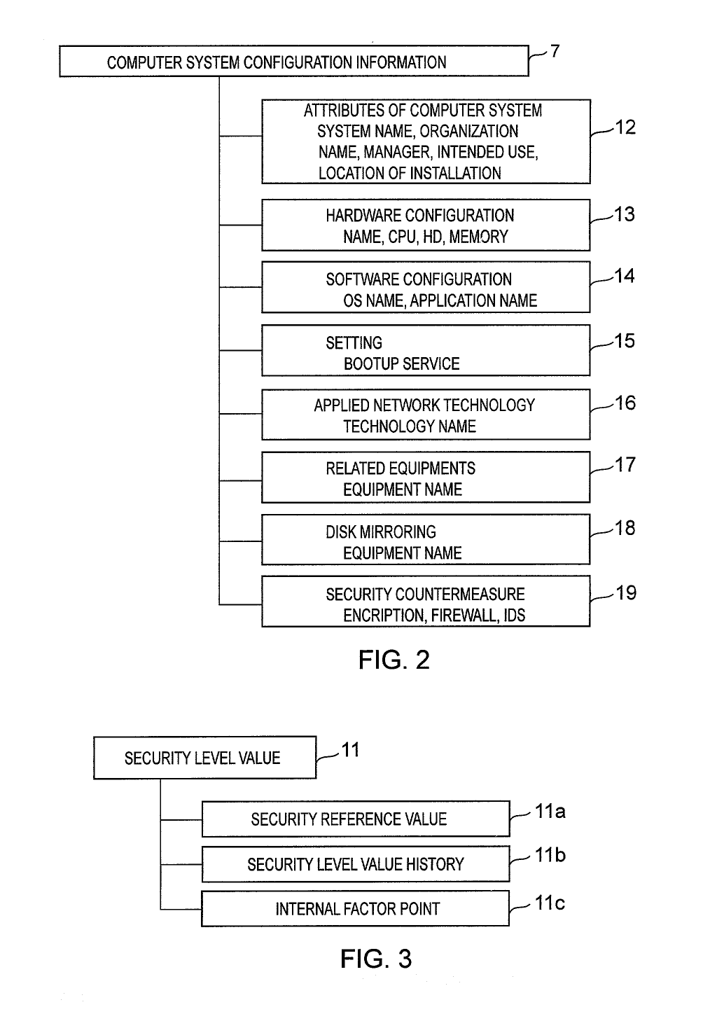

As shown in FIG. 2, as the computer system configuration information 7, besides attribute information 12 such as the name of the computer system, the manager, the place of installation, and the intended use, hardware configuration 13 such as the type of CPU and the memory capacity, software configuration 14 such as the names of the OS and the application program, setting 15 such as the starting service, the network technology used 16, related equipment 17 such as the UPS, mirroring 18 such as RAID, and security measure information 19 such as the names of firewall and IDS are stored.

In the system manager information 8 shown in FIG. 1, the name of the manager (denoted by reference numeral 21 in FIG. 1) of the system 6 to be monitored, and the address to which the information is offered are stored. In the organization information 9, the name of the organization wherein the aforementioned manager 21 belongs, the name of the manager (executive; indicated with Key 22 in the figure) of the organization, and the address to which the information is offered are stored being associated with the aforementioned system manager information 8.

The vulnerability modification information 10 is comprised for each system by recording the work log of the vulnerability modification, which the aforementioned system manager 21 has applied based on the vulnerability information. As illustrated in FIG. 3, the aforementioned security level value 11 comprises the security reference value 11a, the security level value history 11b and the internal factor point 11c. The security reference value 11a is a reference value to indicate the security level of the organization to the executive of the organization (manager of the organization 22). It has been predetermined and stored, taking into consideration the damages and the stock price effects of a case when security-related problems should occur at said organization. Further, in the security level value history 11b, security levels computed in the past are stored as the history. The internal factor point 11c is used to obtain the security level. This point 11c will be explained in detail later.

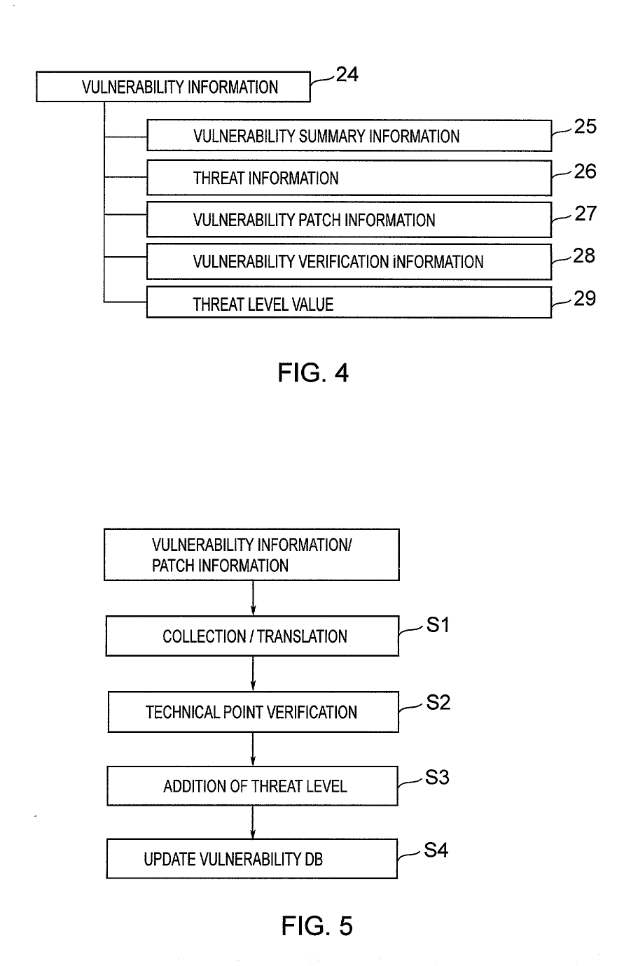

Meanwhile, as illustrated in FIG. 4, in the vulnerability DB 3, as the vulnerability information 24, the vulnerability summary information 25, which contains summary information on the vulnerability; the threat information, which describes the threat due to said vulnerability; the vulnerability patch information 27 to modify said vulnerability; the vulnerability verification information 28, which describes the result of verification of the aforementioned modification in the actual system; and the threat level value 29 to weight the threat of each vulnerability information are stored. As illustrated in FIG. 5, to generate this information, the operator of this system 1 first collects from the external vendor the vulnerability information or patch information, most of which is offered in English, translates the information into other language if necessary (Step S1), and technically verifies the vulnerability information (Step S2). Then, he adds the unique threat level value 29 to each of the vulnerability information (Step S3), and updates the aforementioned vulnerability DB 3 (Step S4). This updating of the DB3 is made through the aforementioned DB updating unit 5.

Meanwhile, as illustrated in FIG. 1, the aforementioned vulnerability monitor processing unit 4 comprises a user authentication unit 30, which authenticates the user who accesses this system 1; an configuration information/manager information/organization information registration unit 31, which receives from the system manager 21 or the like, the input of configuration information 7 and manager information 8, and updates such information; a vulnerability information offering unit 32, which fetches vulnerability information 24 from the aforementioned vulnerability DB 3 and offers it to the aforementioned system manager 21; a vulnerability modification work log recording unit 33, which receives from the system manager 21 the input of the record of the modification work this system manager 21 has applied based on the aforementioned vulnerability information 24, and records it as the aforementioned vulnerability modification information 10; a vulnerability measure information preparing unit 34, which generates vulnerability measure information based on this modification information 10, and reports it to the aforementioned organization manager (executive 22); a security level computing unit 35, which computes the security level of said organization based on both the aforementioned vulnerability information 24 and the information 10 on how the vulnerability is modified; and a security level information preparing unit 36, which offers information on the computed security level to the aforementioned organization manager (executive 22).

These components 1-36, in actuality, are realized by means of one or more computer software programs installed in a storage medium such as a hard disk provided in an ordinary computer system. The CPU of the aforementioned computer system will call this computer software program onto the RAM, and properly run it so that the functions of the present invention will take effect.

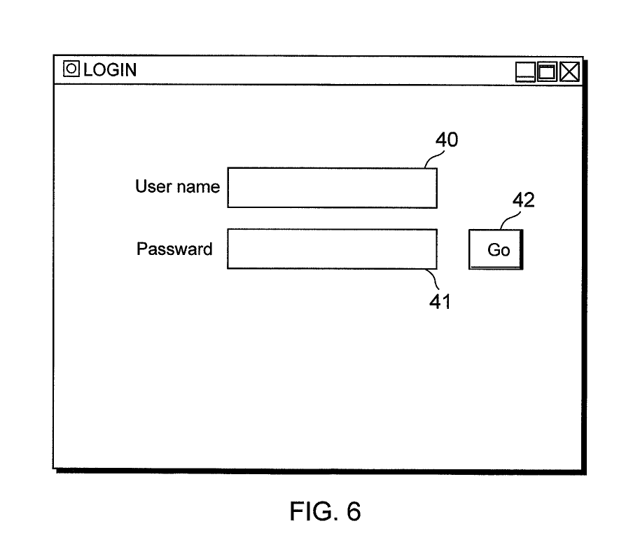

Next, the detailed explanation of the configurations and functions of the aforementioned components 1-36 will be provided based on the diagrams of screen configurations in FIG. 6 and figures thereafter, in reference to actual operation.

FIG. 6 illustrates an example of a login screen for this system 1.

For instance, when the aforementioned system manager 21 connects to the aforementioned system 1, he makes the connection through the Internet from his own terminal, and opens this login screen. Then, he inputs necessary information respectively in the user name input box 40 and the password input box 41 in this login screen, and presses the “Go” button 42. Then, the aforementioned user-authenticating unit 30 authenticates said system manager 21, and establishes the connection to this monitoring system 1.

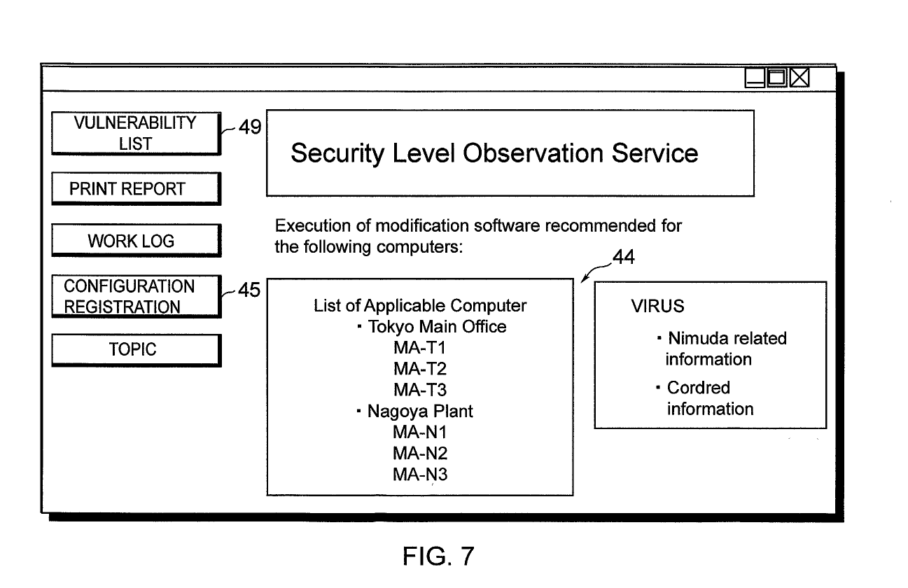

When the connecting user is the system manager 21, according to the result of the aforementioned authentication, the aforementioned vulnerability information offering unit 32 displays the screen illustrated in FIG. 7 on the terminal of the aforementioned system manager 21. This screen displays the computer group 44 for which the execution of modification software is recommended. To make this display, the configuration information 7 of the aforementioned computer system needs to be appropriately registered in the aforementioned user system DB 2. To input or update this configuration information, the configuration registration button 45 in this screen illustrated in FIG. 7 should be pressed.

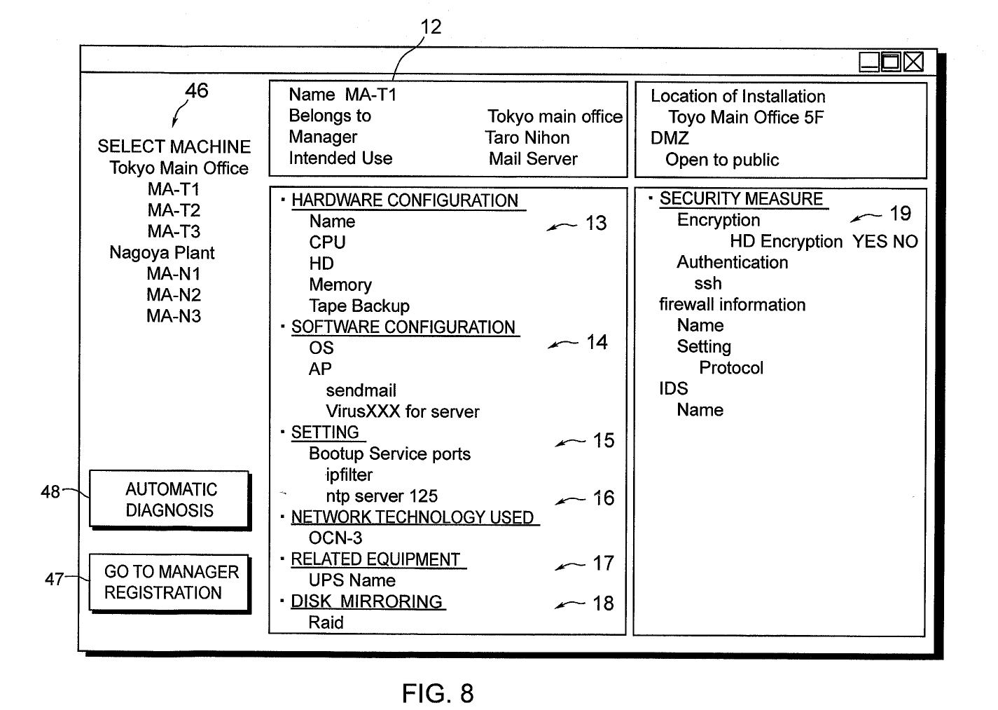

When this button 45 is pressed, the aforementioned configuration information/manager information/organization information registration unit 31 displays the screen shown in FIG. 8. The system manager 21 can input the configuration information on the computer system through this screen. In this embodiment, as indicated in the computer list 46 in this screen, the organization wherein this system manager 21 belongs has both “Tokyo Main Office” and “Nagoya Plant”. Further, as the computers to be monitored, three computers; i.e., MA-T1, MA-T2 and MA-T3 at Tokyo Main Office and three computers; i.e., MA-N1, MA-N2 and MA-N3 at Nagoya Plant are respectively installed and connected to the network.

Of these, this screen displays the system configuration information on MA-T1. Through this screen, each of the information 12-19 explained in reference to FIG. 2 is inputted for each system. Here, it is essential that the name of the system manager is registered, and then, this system manager information can be edited by pressing the manager registration button indicated with Key 47 in this figure.

Furthermore, in the present embodiment, an automatic diagnostic button 48 is provided in this screen. Each of the aforementioned information can be automatically obtained from the computer system 6 to be monitored, by pressing this automatic diagnostic button 48. In other words, as illustrated in FIG. 1, to the aforementioned computer system 6, a configuration information obtaining system 60, which obtains the configuration information on this computer system 6, is connected. Then, when the aforementioned button 48 is pressed, the aforementioned configuration information/manager information/organization information registration unit 31 can start the aforementioned configuration information obtaining system 60 to obtain all or a part of the configuration information on the aforementioned computer system 6.

When the system manager 21 accesses this vulnerability monitoring system 1, the vulnerability information offering unit 32 compares the configuration information 7 registered as explained above in the user system DB 2 and the vulnerability information 24 in the aforementioned vulnerability DB 3. If this vulnerability DB 3 contains vulnerability information 24 that is compatible with the hardware configuration, etc. of the aforementioned system 6, this computer is picked up as a computer that needs security measures, and displayed in the list indicated with Key 44 in the screen illustrated in FIG. 7. In this example, all of the aforementioned computers are picked up as a computer system that needs vulnerability modification. In this manner, each of the vulnerability information 24 will be associated with each of the computer systems to be monitored.

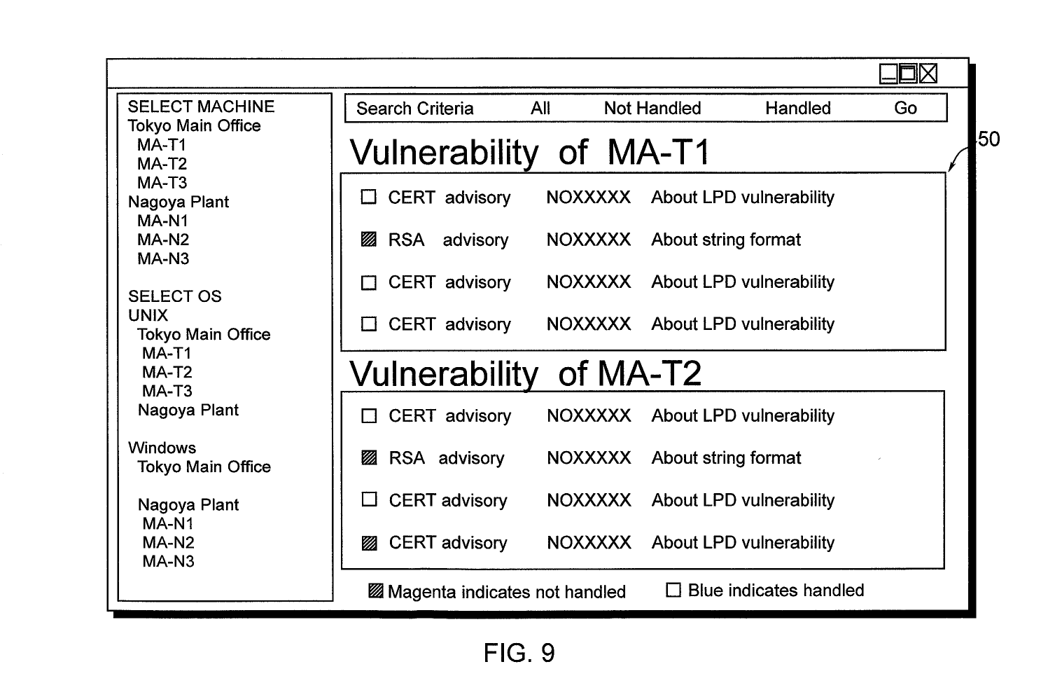

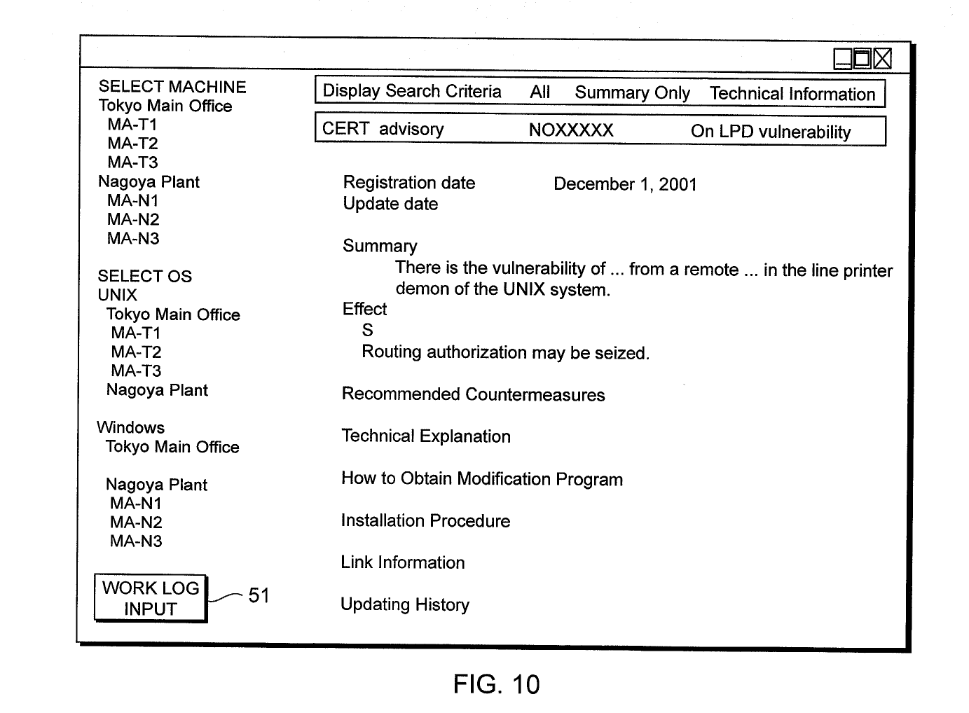

The system manager 21 can view the vulnerability list 50 as illustrated in FIG. 9 by pressing the vulnerability list button 49 in this screen. This vulnerability list is based on the aforementioned attribute information 12, and may be displayed in reference to the system type, the OS, or the location. Then, by clicking each of the vulnerabilities in this screen, he can access more detailed information. In such a case, the aforementioned vulnerability information offering unit 32 fetches each of the detailed information (25-28) illustrated in FIG. 4 from the aforementioned vulnerability DB 3, and displays it as illustrated in FIG. 10.

In this manner, this system manager 21 will be able to check the details on this vulnerability and decide on whether or not to take modifications of this vulnerability. After checking this detailed vulnerability information, if modifications are taken, he will input the vulnerability modification work record by pressing the work log button 51 in this screen.

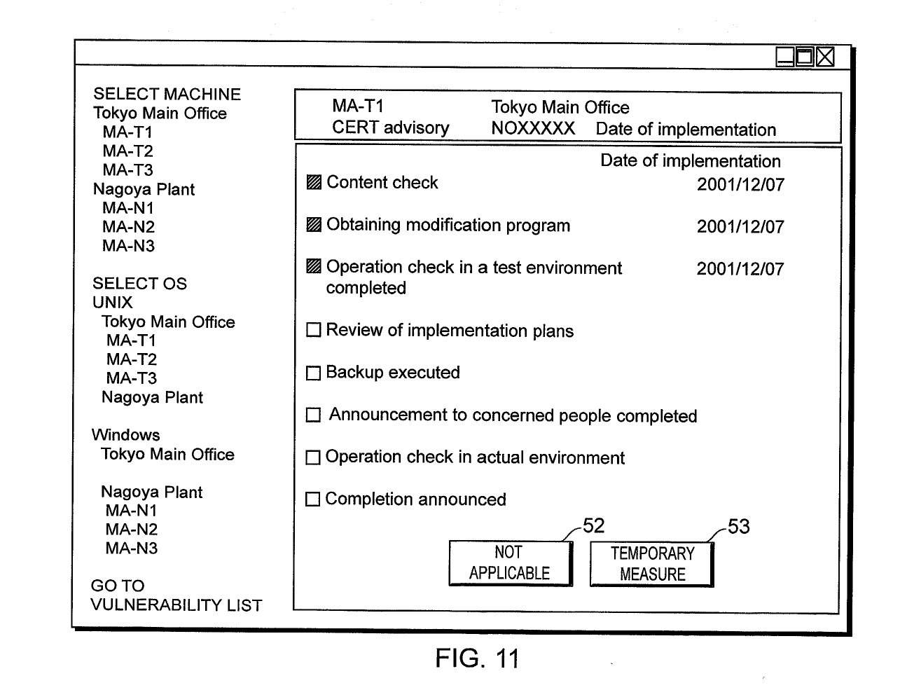

FIG. 11 illustrates the input screen for this work log. In this screen, tasks needed to modify the selected vulnerability are listed in time series, and the system manager 21 will check whether or not each necessary task has been performed, and input the date of implementation.

The aforementioned vulnerability modification work log recording unit 33 stores the vulnerability modification work inputted in this manner in the aforementioned user system DB 2 as the aforementioned vulnerability modification information 10. Then when all the tasks listed in FIG. 11 have been completed, this completion of work will be recorded. Further, this screen includes the “not applicable” button 52 and the “temporary measure” button 53. When the aforementioned vulnerability information does not apply to the system, it can be treated as completed by pressing this not-applicable button 52. The temporary-measure button 53 is used when no effective patch is available for the vulnerability, so measures need to be taken later.

Next, a case when the aforementioned manager 22 of the organization connects to this vulnerability monitoring system 1 will be explained.

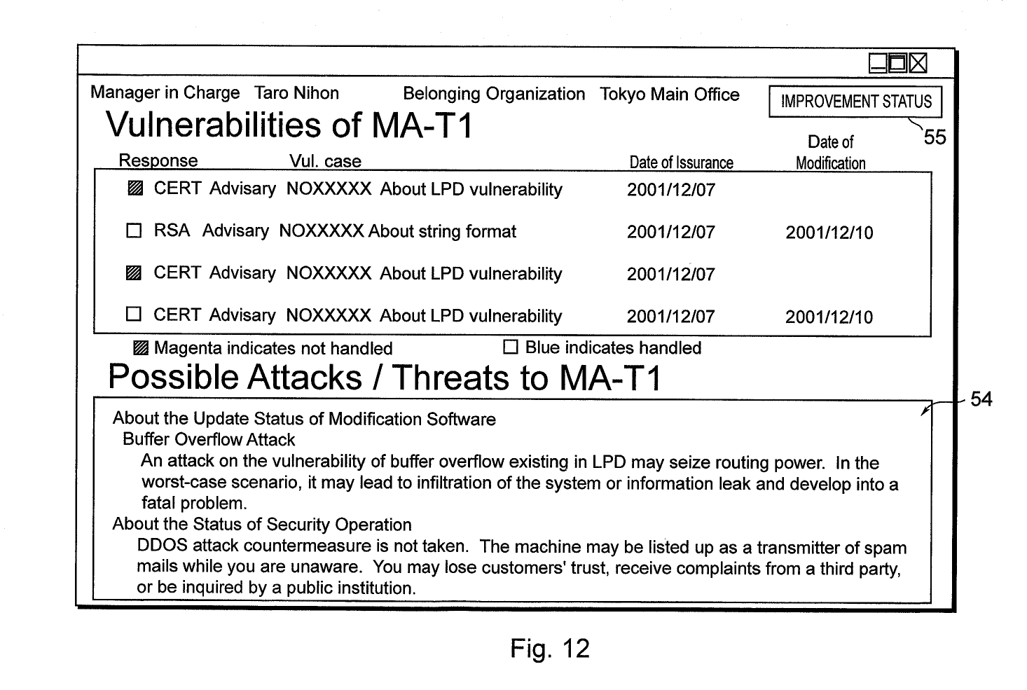

When the aforementioned manager 22 of the organization logs in this system 1, the aforementioned user-authenticating unit 30 will detect, based on the aforementioned organization information 9, that the user is the manager 22 of the organization. Based on this detection, the aforementioned vulnerability information-offering unit 32 generates and presents vulnerability measure information for the manager 22 of the organization as illustrated in FIG. 12. As displayed in this screen, this vulnerability measure information contains vulnerability information, the effective date of the information, and the date when the measure was taken, for instance, for each manager and for each system. The date when the measure was taken is obtained from the aforementioned modification information 10 and is displayed here. Further, based on the vulnerabilities that have not been taken care, the threat information 26, etc. is fetched from the aforementioned vulnerability DB 3, and is displayed in this screen as indicated with Key 54.

By viewing this screen, the manager 22 of the organization will be able to check the state of security management of the network related to the organization or the computer system connected to this network. Also, as this system keeps a record of modification work applied by the system manager 21 and presents it to the manager 22 of the organization, this manager 22 of the organization can appropriately supervise the system manager 21.

Furthermore, if the display button 55 for the state of improvement is pressed in the screen in FIG. 12, the aforementioned security level computing unit 35 will be started and compute the security level for each vulnerability. Also, this security level computing unit 35 comprises a security level value comparing unit 59 to compare the security values between vulnerabilities and between computers and to compute the security level value for each computer and for each network.

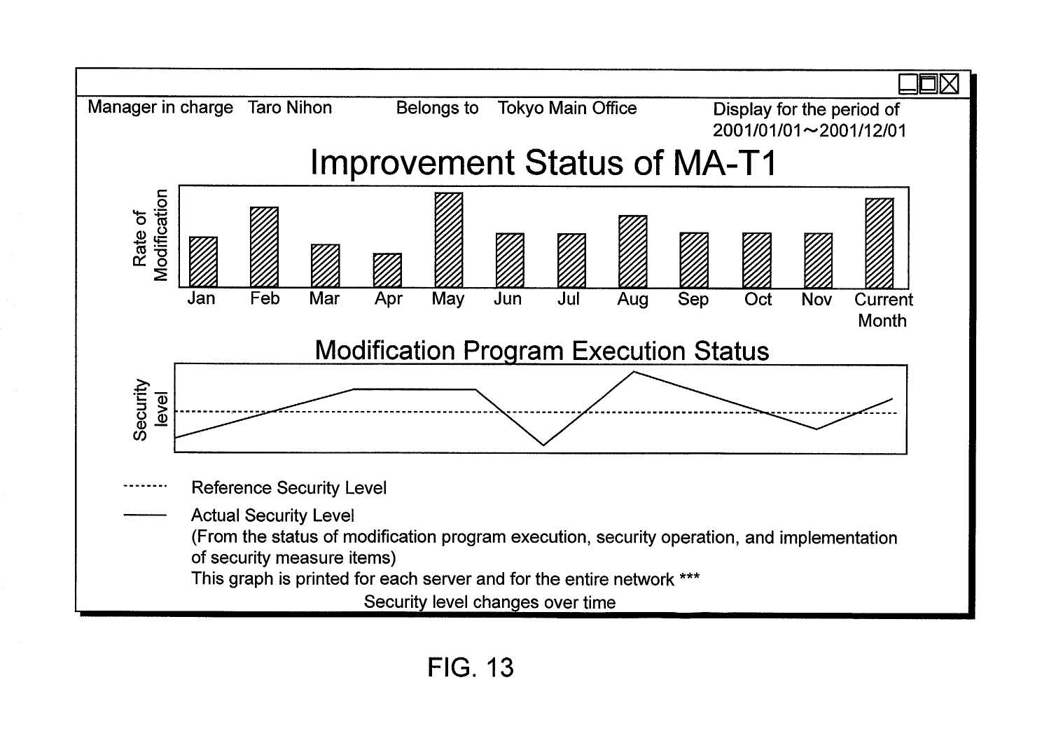

As illustrated in FIG. 13, two graphs illustrate the aforementioned security level; i.e., the first graph 56 and the second graph 57.

The first graph 56 indicates the modification program application rate. For each effective date of each of the vulnerability information, the bar graph indicates the number of modification programs applied. As this graph is based on the effective date, the vulnerability information that became effective in the previous month will be counted in the previous month even if the modification work is applied in the present month.

The second graph 57 is a line graph, which indicates the change in the security level based on the aforementioned modification result. Next, the display procedure of this second graph 57 will be explained.

First, in this embodiment, the security level is defined to be comprised of “internal factor,” “external factor” and “other.”

The internal factor is a static value evaluated by such factors as the presence or absence of security policy or its daily operational situation, the network configuration or the installation of security equipment, and the installation situation. A security consultant derives this internal factor through an evaluation using a check sheet once in, say, three months or six months.

The external factor is a dynamic value obtained by new vulnerability information found each day. This external factor is basically computed each time the aforementioned manager of the organization accesses the system, based on the type of equipment for which the vulnerability information is obtained, the threat level value in the aforementioned vulnerability information, and the information on how many days have passed since this vulnerability information took effect.

The weighting percentages for the computation of security level are as follows: 70% internal factor, 20% external factor and 10% other. However, as the other category indicates human errors or the like, it will be excluded from the evaluation in this embodiment. Therefore, in this embodiment, the security level value is computed from the maximum internal factor value of 70 points and the maximum external factor value of 20 points to the maximum total point of 90 points. Further, as mentioned earlier, the internal factor points are precomputed and stored in the aforementioned user system DB 2.

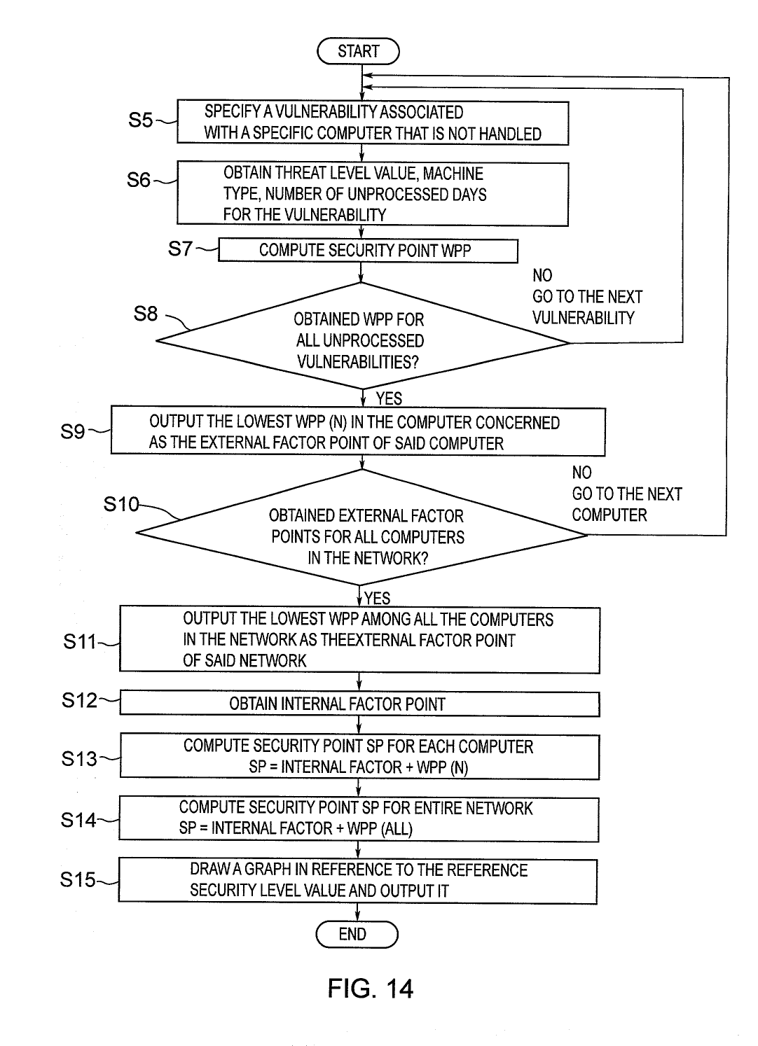

FIG. 14 illustrates a flow chart, which indicates the processes in which the aforementioned security level computing unit 35 computes the security level value.

In this embodiment, to obtain the security level of the entire network, first, in Steps S5-S9 in FIG. 14, the security levels of a plurality of computers belonging in this network are computed. Then, in Steps S10-S14, the security levels of these computers are compared, and the lowest value is adopted as the security level of the network.

For this, the aforementioned security level computing unit 35 first starts processing with the first vulnerability information on the first (n=1) computer from among a plurality of computers belonging in the network (Step S5).

Then, from the user system DB 2, the information on the type of said computer (equipment), the threat level value of the aforementioned vulnerability information, and the information on how many days have passed since this vulnerability information took effect is obtained (Step S6), and the external factor point value wpp on this vulnerability information is computed by means of the following equation (Step S7).

Wpp=20+hp×hk×il×date

Where, Wpp means that the lower the value, the more serious the threat.

hp is the reference parameter, which is −1 here.

hk is the type of the computer (machine type). The hk for security equipment is 2 points, and for any other equipment is 1 point.

il is the aforementioned threat level value (See Key 29 in FIG. 4) added to said vulnerability information. It is set in three steps: S is 4 points, A is 2 points and B is 1 point.

date is the number of days that have passed without taking measures, which is obtained as the difference between the date when the aforementioned vulnerability information took effect and the present date.

These external point values wpp are obtained for all unprocessed vulnerabilities applied in the system concerned (Step S8), and the smallest value of them is outputted as the external factor point value wpp (n) of said computer system (Step S9).

Further, the external factor point values wpp (n) are obtained similarly for all computer systems belonging in the network in the organization concerned (Step S10). In this manner, when the processing has been completed for all computer systems, the smallest wpp in the network is set as the external factor point value wpp (all) for the entire network (Step S11).

Then, the aforementioned security level computing unit 35 obtains the inner factor point 11c from the aforementioned security level value 11 (Step S12), and by adding the aforementioned external factor point wpp (n) and wpp (all) to this, the security level value (SP) is computed (Steps S13, S14).

Next, the aforementioned security level information preparing unit 36 prepares the second graph 57 illustrated in FIG. 13 using the security level value SP, the aforementioned security reference value 11a and the security level value history 11b (Step S15).

That is, in this embodiment, the aforementioned security level information preparing unit 36 fetches the security level value on the last day of each month of the past year from the aforementioned security level value history 11b, and sets that as the security level value for each month. Then, the security level value SP currently obtained is set as the security level value of the present month. Then, as illustrated in FIG. 13, these security values are indicated as a line graph 57 with the aforementioned security reference value as the central value.

With this line graph, even an executive with little technical knowledge will be able to evaluate the security level value of the organization concerned at a glance.

Further, the present invention is not limited to the aforementioned embodiment. Variations may be made without departing from the scope of the invention.

For instance, while the system manager and the manager of the organization receive various kinds of information from the aforementioned vulnerability monitoring system through the Internet in the aforementioned embodiment, this is not the only method. For instance, various kinds of information may be offered through a means such as E-mail.

Also, while the aforementioned security level is indicated using a bar graph and a line graph, this is not the only method. It may be indicated by displaying specific numbers. Further, the specific computing method for the aforementioned security level may be altered in various ways within the scope of the present invention. For instance, the security level obtained using only the external factor points wpp, wpp (n), wpp (all) may be offered without using the internal factor point.

According to the configuration explained above, security information structured such that it can be understood by a person with insufficient knowledge of security technologies can be offered promptly.

What is claimed is:

1. A method for offering security level comprising the steps of:
(a) specifying, based on configuration information on a specific equipment, a vulnerability of said equipment, and associating information of the vulnerability with said equipment, said information of the vulnerability including a threat level value of the vulnerability;
(b) computing a security level value of the vulnerability of the specific equipment based on the type of this equipment, the threat level value of the vulnerability for which no modification has been taken regarding this equipment, and the number of days while the vulnerability has been left without any modification taken for the vulnerability; and
(c) outputting security level information based on the security level value obtained in said step (b).

2. The method according to claim 1, further comprising the steps of
(d) computing a security level value of said equipment by comparing the security level values of vulnerabilities when there are a plurality of vulnerabilities associated with said equipment, which have not been modified, and setting a security level value with the highest threat level value among the security level values of said vulnerabilities as the security level value of said equipment, and wherein
said step (c) outputs the security level information based on the security value of said equipment obtained in step (d).

3. The method according to claim 2 further comprising the steps of
(e) computing the security level value of a network when a plurality of equipments are connected to the network, by comparing security level values of the equipments, and setting a security level value with the highest threat level value among the security level values of said equipments as the security level value of said network, and wherein
said step (c) outputs security level information based on the security value of said network.

4. The method according to claim 1, wherein said step (c) outputs security information based on both security level value obtained in the step (b) and basic security information computed based on a basic configuration, etc. of the equipment or the network.

5. The method according to claim 1, wherein said step (c) comprises a step of expressing said security level value in comparison with a security level reference value of a relevant system or the network to which said system is connected.

6. A system for computing a security level of a computer system, said system comprising:
a configuration information storing unit for storing configuration information on the computer system to be monitored;
a vulnerability information storing unit for storing various types of updated vulnerability information including at least a threat level value of the vulnerability;
a vulnerability information offering unit to extract vulnerability information to be applied to said computer system from said vulnerability information storing unit based on said configuration information, and to associate the vulnerability information with this computer system;
a vulnerability modification information storing unit for storing the information on whether or not a system manager has applied modification work based on this vulnerability information;
a security level computing unit for computing, regarding a specific equipment, a security level regarding the vulnerability of said equipment from a type of this equipment, the threat level value of the vulnerability that has not been modified with regarding this equipment, and the number or days while the vulnerability has been left without any modification taken; and
a security level information generating unit for generating and output security level information based on the security level value obtained in said computing unit.

7. The system according to claim 6, said system further comprising,
a security level value comparing unit to compute a security level value of said equipment by comparing security level values of vulnerabilities when there are a plurality of vulnerabilities associated with said equipment, which have not been modified, and setting a security level value with the highest threat level among the security level values of said vulnerabilities as the security level value of said equipment, and wherein
said security level information generating unit generates security level information based on said security level value of said equipment computed by the security level value comparing unit.

8. The system according to claim 7, wherein
said security-level value comparing unit computes a security value of a network by comparing security level values of equipments when a plurality of equipments are connected to said network, and setting a security level value with the highest level of threat among the security level values of said equipments as the security value level of said network; and
said security level information generating unit outputs security level information based on the security level value of said network computed by the security level value comparing unit.

9. The system according to claim 6, wherein
said security level information generating unit outputs security information based on both security value obtained in said security level computing unit and basic security information computed based on a basic configuration, etc. of an equipment or a network.

10. The system according to claim 6, wherein
said security level information generating unit expresses said security level value in comparison with a security reference value of a relevant system or the network to which this system is connected.
